(19) United States
(12) Patent Application Publication
(10) Pub. No.: US 2023/0344941 A1
(43) Pub. Date: Oct. 26, 2023

(54) METHOD FOR ECHO CANCELLATION, ECHO CANCELLATION DEVICE AND ELECTRONIC EQUIPMENT

(71) Applicant: Shenzhen Bluetrum Technology Co., Ltd., Shenzhen (CN)

(72) Inventors: Minghui Song, Shenzhen (CN); Zhangyi Yan, Shenzhen (CN); Jinhong Lin, Shenzhen (CN)

(21) Appl. No.: 17/984,274

(22) Filed: Nov. 10, 2022

(30) Foreign Application Priority Data
Apr. 21, 2022 (CN) 202210427018.4

(51) Int. Cl. H04M 9/08; G10L 21/0232; G10L 25/18

(52) U.S. Cl. CPC H04M 9/082; G10L 21/0232; G10L 25/18; G10L 2021/02082

(57) ABSTRACT

Method for echo cancellation, echo cancellation device and electronic equipment, wherein the method includes: acquiring far-end signals and near-end signals generated by an electronic equipment during a phone conversation; performing linear filtering processing on far-end signals and near-end signals to obtain an initial error frequency spectrum; determining a current state of the electronic equipment based on far-end signals and near-end signals, the current state comprising a dual-talk state; determining a secondary filtering weight coefficient according to the current state; performing secondary filtering on far-end signals and near-end signals based on the secondary filtering weight coefficient and performing differential output to obtain a secondary differential frequency spectrum; comparing the initial error frequency spectrum with the secondary differential frequency spectrum to obtain a target output frequency spectrum.

### PRIORITY CLAIM

This application claims the benefit of and priority to the Chinese Patent Application No. 202210427018.4, filed to the Chinese patent office on Apr. 21, 2022 and entitled “Method for Echo Cancellation, Echo Cancellation Device and Electronic Equipment”, which is hereby incorporated by reference in its entirety.

### TECHNICAL FIELD

Embodiments of the present application relate to the technical field of echo cancellation, and in particularly relate to a method for echo cancellation, echo cancellation device and electronic equipment.

### BACKGROUND

Acoustic echo cancellation (AEC) technology is widely used in modern communication electronic equipments. For example, in the application of Bluetooth headphones, the effect of echo cancellation affects the quality of phone conversation between both parties. In the existing echo cancellation technology, the echo signal is mainly estimated by a linear adaptive filter, then the estimated echo is subtracted from the near-end signal to obtain an error signal, and then the error signal is subjected to nonlinear processing as the final output.

In the process of realizing the embodiments of the present application, the inventor of the present application found that: the traditional linear adaptive filter has the problems of poor echo cancellation effect and excessive residual echo when working in the dual-talk situation and the situation with near-end noise.

### SUMMARY

In a first aspect, an embodiment of the present application provides an echo cancellation method, and the method includes: acquiring far-end signals and near-end signals generated by an electronic equipment during a phone conversation; performing linear filtering processing on the far-end signals and the near-end signals to obtain an initial error frequency spectrum; determining a current state of the electronic equipment based on the far-end signals and the near-end signals, wherein the current state comprises a dual-talk state; determining a secondary filtering weight coefficient according to the current state; performing secondary filtering on the far-end signals and the near-end signals based on the secondary filtering weight coefficient and performing differential output to obtain a secondary differential frequency spectrum; comparing the initial error frequency spectrum with the secondary differential frequency spectrum to obtain a target output frequency spectrum.

In some embodiments, the step of performing linear filtering processing on the far-end signals and the near-end signals to obtain an initial error frequency spectrum includes: performing Fourier transform on the far-end signals to obtain far-end frequency domain information, and performing Fourier transform on the near-end signals to obtain near-end frequency domain information; performing filtering processing on the far-end frequency domain information by using the filter weight coefficient of the previous frame to obtain an echo frequency spectrum; subtracting the echo frequency spectrum from the near-end frequency domain information to obtain an initial error frequency spectrum.

In some embodiments, the step of determining a current state of the electronic equipment based on the far-end signals and the near-end signals includes the following steps: dividing the far-end frequency domain information and the near-end frequency domain information into a plurality of sub-bands respectively; calculating a normalized cross-correlation coefficient of the far-end frequency domain information and the near-end frequency domain information in the same sub-band; determining that the current state of the electronic equipment is a dual-talk state when the normalized cross-correlation coefficient is greater than a dual-talk detection threshold; determining that the current state is a single-talk state when the normalized cross-correlation coefficient is not greater than the dual-talk detection threshold.

In some embodiments, the step of calculating a normalized cross-correlation coefficient of the far-end frequency domain information and the near-end frequency domain information in the same sub-band includes: calculating the cross-correlation coefficient of the far-end frequency domain information and the near-end frequency domain information in the same sub-band under the same frame; calculating the normalized cross-correlation coefficient of the far-end frequency domain information and the near-end frequency domain information in the same sub-band based on the cross-correlation coefficient.

In some embodiments, when the current state is the single-talk state, the step of determining the secondary filtering weight according to the current state includes: using the filter weight coefficient of the previous frame as the secondary filtering weight.

In some embodiments, when the current state is the dual-talk state, then the step of determining the secondary filtering weight according to the current state includes: updating the filter weight coefficient of the previous frame to obtain a filter weight coefficient of the current frame; using the filter weight coefficient of the current frame as the secondary filtering weight.

In some embodiments, the step of performing secondary filtering on the far-end signals and the near-end signals based on the secondary filtering weight coefficient and performing differential output to obtain a secondary differential frequency spectrum includes: performing secondary filtering processing on the far-end frequency domain information by using the secondary filtering weight coefficient to obtain a secondary filtering result; subtracting the secondary filtering result from the near-end frequency domain information to obtain the secondary differential frequency spectrum.

In some embodiments, the step of comparing the initial error frequency spectrum with the secondary differential frequency spectrum to obtain a target output frequency spectrum includes: taking the initial error frequency spectrum as the target output frequency spectrum when the initial error frequency spectrum is smaller than the secondary differential frequency spectrum; taking the secondary differential frequency spectrum as the target output frequency spectrum when the initial error frequency spectrum is larger than the secondary differential frequency spectrum.

In some embodiments, after the step of comparing the initial error frequency spectrum with the secondary differential frequency spectrum to obtain a target output frequency spectrum, the method further includes: performing inverse Fourier transform on the target output frequency spectrum followed by overlap-adding to obtain a target output signal.

In a second aspect, an embodiment of the present application provides an echo cancellation device, and the device includes: a sampling signal acquisition module, being configured to acquire far-end signals and near-end signals generated by an electronic equipment during a phone conversation; a linear filtering module, being configured to perform linear filtering processing on the far-end signals and the near-end signals to obtain an initial error frequency spectrum, a state determining module, being configured to determine a current state of the electronic equipment based on the far-end signals and the near-end signals, wherein the current state includes a dual-talk state; a secondary filtering weight coefficient determining module, being configured to determine a secondary filtering weight coefficient according to the current state; a secondary filtering module, being configured to perform secondary filtering on the far-end signals and the near-end signals based on the secondary filtering weight coefficient and performing differential output to obtain a secondary differential frequency spectrum; a target acquisition module, being configured to compare the initial error frequency spectrum with the secondary differential frequency spectrum to obtain a target output frequency spectrum.

In a third aspect, an embodiment of the present application provides an electronic equipment, which includes: at least one processor, and a memory, the memory being communicatively connected with the at least one processor, the memory storing instructions executable by the at least one processor, wherein the instructions, when executed by the at least one processor, enable the electronic equipment to implement the method in any of the aspects described above.

In a fourth aspect, an embodiment of the present application provides a nonvolatile computer-readable storage medium which stores computer-executable instructions, and the computer-executable instructions, when executed by an electronic equipment, cause the electronic equipment to perform the method as described above.

### BRIEF DESCRIPTION OF THE DRAWINGS

One or more embodiments are illustrated by pictures in corresponding attached drawings, and this does not constitute limitation on the embodiments. Elements with the same reference numerals in the attached drawings are shown as similar elements, and the pictures in the attached drawings do not constitute scale limitation unless otherwise stated particularly.

FIG. 1 is a schematic block diagram of an electronic equipment according to an embodiment of the present application.

FIG. 2 is a schematic flowchart diagram of a method for echo cancellation according to an embodiment of the present application.

FIG. 3 is a schematic flowchart diagram of the method for echo cancellation according to another embodiment of the present application.

FIG. 4 is a schematic structural diagram of an echo cancellation device according to the present application.

FIG. 5 is a schematic view of the hardware structure of a controller in the electronic equipment according to the present application.

### DETAILED DESCRIPTION

The present application will be described in detail hereinafter with reference to specific embodiments. The following embodiments will facilitate the further understanding of the present application by those skilled in the art, but are not intended to limit the present application in any way. It shall be noted that, those of ordinary skill in the art can make several modifications and improvements without departing from the concept of the present application. All these modifications and improvements belong to the scope claimed in the present application.

In order to make objectives, technical solutions, and advantages of the present application clearer, the present application will be further described in detail hereinafter with reference to attached drawings and embodiments. It shall be appreciated that, the specific embodiments described herein are only used to explain the present application, and are not used to limit the present application.

It shall be noted that, all features in the embodiments of the present application may be combined with each other without conflict, and all the combinations are within the scope claimed in the present application. In addition, although functional module division is made in the schematic diagrams of the device and logical sequences are shown in the flowchart diagrams, in some cases, the steps shown or described can be executed with module division and sequences different from those in the schematic diagrams of the device and the flowchart diagrams. Furthermore, words such as “first”, “second”, and “third” used herein do not limit the data and execution order, but only distinguish same or similar items with basically the same functions and effects.

Unless otherwise defined, all technical and scientific terms used in this specification have the same meanings as commonly understood by those skilled in the art of the present application. In this specification, the terms used in the specification of the present application are only for the purpose of describing specific embodiments, and are not intended to limit the present application. The term “and/or” used in this specification includes all combinations of one or more associated items listed.

In addition, the technical features involved in various embodiments of the present application described below can be combined with each other as long as they do not conflict with each other.

The method for echo cancellation and device provided by the embodiment of the present application may be applied to electronic equipments, and the electronic equipments may be Bluetooth headphones, wired headphones and other equipments used for communication by phones. Taking the Bluetooth headphones as an example, the Bluetooth headphones are connected via Bluetooth with the smart phone which is required to make a conversation, and a user can make the conversation by wearing the Bluetooth headphones.

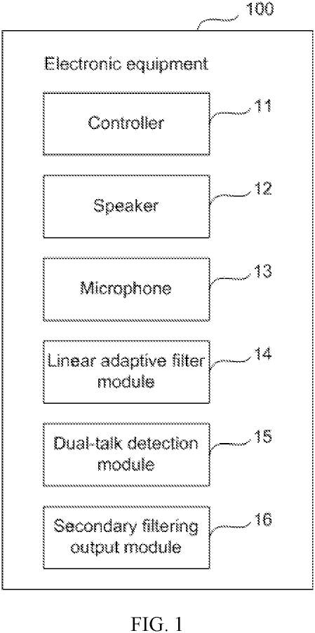

As shown in FIG. 1, an electronic equipment 100 includes a controller 11, a speaker 12 and a microphone 13. The controller 11 connects with the speaker 12 and the microphone 13. The speaker 12 is used for playing sounds which are far-end signals. The microphone 13 is used for collecting sounds, and the sounds collected by the microphone 13 include the voice of the user, echo and background noise, which are near-end signals. The controller 11 is used for acquiring the far-end signals and the near-end signals generated by the user during a phone conversation.

The electronic equipment 100 further includes a linear adaptive filter module 14, a dual-talk detection module 15 and a secondary filtering output module 16. The controller 11 connects with the linear adaptive filter module 14, the dual-talk detection module 15 and the secondary filtering output module 16.

The linear adaptive filter module 14 is configured to perform linear filtering processing on the far-end signals and the near-end signals to obtain an initial error frequency spectrum, and the controller 11 obtains the initial error frequency spectrum from the linear adaptive filter module 14.

The dual-talk detection module 15 is used for receiving the far-end signal and the near-end signal forwarded by the controller 11, and determining the current state of the electronic equipment 100 based on the far-end signal and the near-end signal, wherein the current state includes a dual-talk state and a single-talk state. The dual-talk state means that both far-end signal and near-end signal exist, and the single-talk state means that only the near-end signal exists.

The controller 11 is further configured to determine a secondary filtering weight coefficient according to the current state.

The secondary filtering output module 16 is configured to receive the far-end signal and the near-end signal forwarded by the controller 11 as well as the secondary filtering weight coefficient, perform secondary filtering on the far-end signal and the near-end signal, and perform differential output to obtain a secondary differential frequency spectrum; and compare the initial error frequency spectrum with the secondary differential frequency spectrum to obtain a target output frequency spectrum.

By performing preliminary filtering processing on the far-end signal and the near-end signal, detecting the dual-talk state and performing secondary filtering processing using the controller 11, the linear adaptive filter module 14, the dual-talk detection module 15 and the secondary filtering output module 16, the electronic equipment 100 achieves echo cancellation in the dual-talk state and the situation with near-end noise, and solves the problems of poor echo cancellation effect and excessive secondary filtering result, thereby effectively improving the quality of voice call.

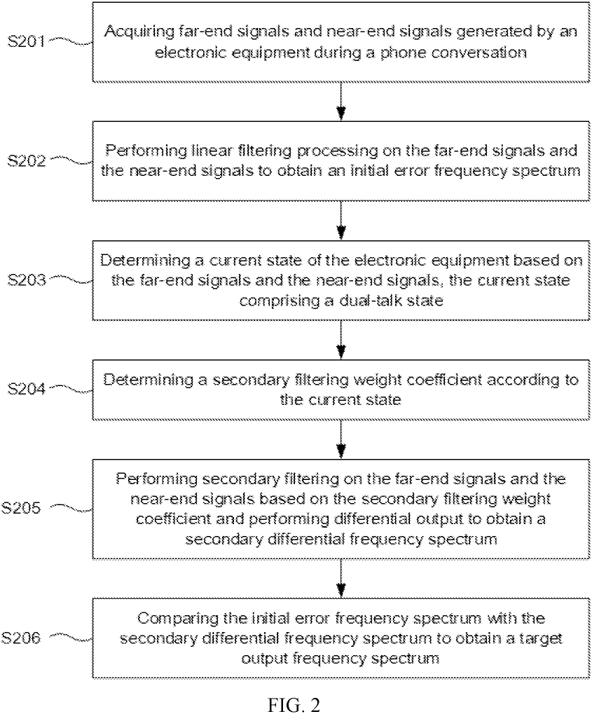

Please refer to FIG. 2, which is a schematic flowchart diagram of a method for echo cancellation according to an embodiment of the present application. The method is applied to the electronic equipment 100 and may be executed by the processor 111 in the electronic equipment 100. As shown in FIG. 2, the method includes:

S201: acquiring far-end signals and near-end signals generated by an electronic equipment during a phone conversation.

A controller of the electronic equipment acquires the far-end signals and the near-end signals generated by the electronic equipment during the phone conversation, wherein the far-end signals are sound signals played by the speaker, and the near-end signals include the voice of the user, echo and/or background noise.

The far-end signal is represented by x(n), and the far-end signal x(n) is represented by Equation 1:

$$x \left(n\right) = {\left[x \left(i\right) , x \left(i - 1\right) , … , x \left(i - M + 1\right)\right]}^{T} \qquad \text{Equation 1;}$$

The near-end signal is represented by d(n), and the near-end signal d(n) is represented by Equation 2:

$$d \left(n\right) = {\left[d \left(i\right) , d \left(i - 1\right) , … , d \left(i - M + 1\right)\right]}^{T} \qquad \text{Equation 2,}$$

Wherein M represents the number of sampling points of the far-end signal x(n) or the near-end signal d(n) in a frame, and i represents the i^{th} sampling point of the controller of the electronic equipment when collecting the far-end signal x(n) or the near-end signal d(n).

S202: performing linear filtering processing on the far-end signals and the near-end signals to obtain an initial error frequency spectrum.

After the controller of the electronic equipment obtains the far-end signal x(n) and the near-end signal d(n), the linear adaptive filter module performs linear filtering processing on the far-end signal x(n) and the near-end signal d(n) to obtain the initial error frequency spectrum.

In some embodiments, the step of performing linear filtering processing on the far-end signals and the near-end signals to obtain an initial error frequency spectrum includes:
performing Fourier transform on the far-end signals to obtain far-end frequency domain information, and performing Fourier transform on the near-end signals to obtain near-end frequency domain information;
performing filtering processing on the far-end frequency domain information by using the filter weight coefficient of the previous frame to obtain an echo frequency spectrum;
subtracting the echo frequency spectrum from the near-end frequency domain information to obtain an initial error frequency spectrum.

Specifically, firstly, Fourier transform is performed on the far-end signal x(n) to obtain far-end frequency domain information X(n) and then Fourier transform is performed on the near-end signal d(n) to obtain near-end frequency domain information D(n). The far-end frequency domain information X(n) is represented by Equation 3, and the near-end frequency domain information D(n) is represented by Equation 4:

$$X \left(n\right) = f f t \left(\left[x \left(n - 1\right) ; x \left(n\right)\right] \cdot w i n\right) \qquad \text{Equation 3;}$$

$$D \left(n\right) = f f t \left(\left[d \left(n - 1\right) ; d \left(n\right)\right] \cdot w i n\right) \qquad \text{Equation 4;}$$

Wherein X(n) represents the far-end frequency domain information of the n^{th} frame, D(n) represents the near-end frequency domain information of the n^{th} frame, win represents the hanning window with a length of 2*M, and ƒƒt represents the Fourier transform.

Then, filtering processing is performed on the far-end frequency domain information X(n) by using the filter weight coefficient of the previous frame to obtain the echo frequency spectrum. That is, the far-end frequency domain information X(n) is filtered in the frequency domain to obtain the echo frequency. The obtained echo frequency spectrum is represented by Y(n), and is calculated by Equation 5:

$$Y \left(n\right) = {W}_{f 1} \left(n - 1\right) \cdot X \left(n\right) \qquad \text{Equation 5;}$$

Wherein W_{ƒ1}(n-1) represents the filter weight coefficient of previous frame.

Finally, the echo frequency spectrum Y(n) is subtracted from the near-end frequency domain information D(n) to obtain the initial error frequency spectrum E₁(n), which is represented by Equation 6:

$${E}_{1} \left(n\right) = D \left(n - 1\right) - Y \left(n\right) \qquad \text{Equation 6.}$$

The obtained initial error frequency spectrum E₁(n) can preliminarily cancel the echo.

S203: determining a current state of the electronic equipment based on the far-end signals and the near-end signals, the current state comprising a dual-talk state.

Through the dual-talk detection module, the dual-talk state is detected. In some embodiments, the current state includes the dual-talk state and the step of determining a current state of the electronic equipment based on the far-end signals and the near-end signals includes the following steps:
dividing the far-end frequency domain information and the near-end frequency domain information into a plurality of sub-bands respectively;
calculating a normalized cross-correlation coefficient of the far-end frequency domain information and the near-end frequency domain information in the same sub-band (S301);
determining that the current state of the electronic equipment is the dual-talk state when the normalized cross-correlation coefficient is greater than a dual-talk detection threshold.

Specifically, the far-end frequency domain information X(n) and the near-end frequency domain information D(n) are respectively divided into several sub-bands, e.g., divided into P sub-bands, wherein P is a positive integer (1≤P≤M). Taking the case where the far-end frequency domain information X(n) is divided into three sub-bands as an example, the sampling frequency of the far-end frequency domain information X(n) is 8 KHz, and the frequency ranges of the three sub-bands may be set to 0 hz -3000 hz, 3001 hz - 5500 hz and 5501 hz -8000 hz, respectively. Of course, the frequency ranges of the sub-bands may be set according to actual needs.

Then, the normalized cross-correlation coefficient of the far-end frequency domain information X(n) and the near-end frequency domain information D(n) in the same sub-band is calculated. Further speaking, the step of calculating a normalized cross-correlation coefficient of the far-end frequency domain information X(n) and the near-end frequency domain information D(n) in the same sub-band includes: calculating the cross-correlation coefficient of the far-end frequency domain information and the near-end frequency domain information in the same sub-band under the same frame; calculating the normalized cross-correlation coefficient of the far-end frequency domain information and the near-end frequency domain information in the same sub-band based on the cross-correlation coefficient. The cross-correlation coefficient includes the near-end signal smooth power spectrum, the far-end signal smooth power spectrum, the smooth power spectrum of the near-end and far-end signals and the cross-correlation coefficients of the near-end and far-end signals, which may be calculated by Equations 7 to 10 respectively:

$${S}_{d}^{L} \left(n\right) = g a m m a \cdot {S}_{d}^{L} \left(n\right) + \left(1 - g a m m a\right) {D}^{L} \left(n\right) \cdot c o n j \left({D}^{L} \left(n\right)\right) \qquad \text{Equation 7;}$$

$${S}_{x}^{L} \left(n\right) = g a m m a \cdot {S}_{x}^{L} \left(n\right) + \left(1 - g a m m a\right) {X}^{L} \left(n\right) \cdot c o n j \left({X}^{L} \left(n\right)\right) \qquad \text{Equation 8;}$$

$${S}_{x d}^{L} \left(n\right) = g a m m a \cdot {S}_{x d}^{L} \left(n\right) + \left(1 - g a m m a\right) {X}^{L} \left(n\right) \cdot c o n j \left({D}^{L} \left(n\right)\right) \qquad \text{Equation 9;}$$

$${C}_{x d}^{L} \left(n\right) = {S}_{x d}^{L} \left(n\right) \cdot c o n j \left({S}_{x d}^{L} \left(n\right)\right) / \left({S}_{x}^{L} \left(n\right) \cdot {S}_{d}^{L} \left(n\right) + σ\right) \qquad \text{Equation 10;}$$

Wherein

$${S}_{d}^{L} \left(n\right)$$

represents the near-end signal smooth power spectrum of the L^{th} sub-band;

$${S}_{x}^{L} \left(n\right)$$

represents the far-end signal smooth power spectrum of the L^{th} sub-band;

$${S}_{x d}^{L} \left(n\right)$$

represents the smooth power spectrum of the near-end and far-end signals of the L^{th} sub-band;

$${C}_{x d}^{L} \left(n\right)$$

represents the correlation coefficient of the near-end and far-end signals of the L^{th} sub-band; gamma represents smooth factor; σ represents the division protection factor, and the division protection factor may be set σ > 0; conj represents conjugate operation.

Then, based on the cross-correlation coefficients (including the near-end signal smooth power spectrum

$${S}_{d}^{L} \left(n\right) ,$$

the far-end signal smooth power spectrum

$${S}_{x}^{L} \left(n\right) ,$$

the smooth power spectrum of near-end and far-end signals

$${S}_{x d}^{L} \left(n\right) ,$$

the correlation coefficient of the near-end and far-end signals

$$\left({C}_{x d}^{L} \left(n\right)\right) ,$$

the normalized cross-correlation coefficient of the far-end frequency domain information X(n) and the near-end frequency domain information D(n) in the same sub-band can be calculated by Equation 11 and Equation 12:

$$w e i g h t {s}^{k} \left(n\right) = \frac{{S}_{x}^{k} \left(n\right)}{\sum {S}_{x}^{k} \left(n\right) + σ} \qquad \text{Equation 11;}$$

$${ξ}^{L} \left(n\right) = \sum \left(w e i g h t {s}^{k} \left(n\right) \cdot {C}_{x d}^{k} \left(n\right)\right) \qquad \text{Equation 12;}$$

Wherein ζ^{L}(n) represents the normalized cross-correlation coefficient of the far-end frequency domain information X(n) and the near-end frequency domain information D(n) of the n^{th} frame in the L^{th} sub-band; and k represents all the frequency points in the L^{th} sub-band.

After obtaining the normalized cross-correlation coefficient ζ^{L}(n) of the far-end frequency domain information X(n) and the near-end frequency domain information D(n) of the n^{th} frame in the L^{th} sub-band, the normalized cross-correlation coefficient ζ^{L}(n) is compared with a talkback detection threshold T1 (S302). In the case where there is no need to estimate the time delay, for example, when the electronic equipment is Bluetooth headphones, the distance between the speaker and the near-end microphone is fixed and is usually between 15 mm and 30 mm. This distance makes the time delay between the near-end signal and the far-end signal negligible for the filter, and therefore, the talkback detection threshold T1 may be set to a value slightly smaller than 1, e.g., 0.9.

When the normalized cross-correlation coefficient (n) is greater than the talkback detection threshold T1, it is determined that the current state of the electronic equipment is the dual-talk state. Correspondingly, when the normalized cross-correlation coefficient ζ^{L}(n) is not greater than the talkback detection threshold T1, it is determined that the current state of the electronic equipment is the single-talk state.

S204: determining a secondary filtering weight coefficient according to the current state.

In some embodiments, when the current state is the dual-talk state, the step of determining the secondary filtering weight coefficient according to the dual-talk state includes:
updating the filter weight coefficient of the previous frame to obtain a filter weight coefficient of the current frame;
using the filter weight coefficient of the current frame as the secondary filtering weight.

Specifically, in the dual-talk state, in order to continuously approach the real echo path, it is necessary to update the filter weight coefficient W_{ƒ1}(n-1) of previous frame, and the updating process may be performed as Equation 13:

$${W}_{f 1} \left(n\right) = {W}_{f 1} \left(n - 1\right) + μ \text{Δ} W \qquad \text{Equation 13;}$$

Wherein W_{f1}(n) represents the updated filter weight coefficient of previous frame, i.e., the filter weight coefficient of the current frame; µ represents the step-size factor, ΔW represents the adjustment amount of the filter coefficient, and the calculation methods of the adjustment amount of the filter coefficient ΔW include but not limited to least mean square (LMS), recursive least squares (RLS) and Kalman algorithm or the like.

Furthermore, the filter weight coefficient W_{ƒ1}(n) of the current frame is used as the secondary filtering weight.

Correspondingly, when the normalized cross-correlation coefficient ζ^{L}(n) is not greater than the talkback detection threshold T1, then it is determined that the current state of the electronic equipment is the single-talk state, which means that there is only the influence of echo of the near-end signal. At this time, it is unnecessary to update the filter weight coefficient W_{ƒ1}(n-1) of the previous frame, and the filter weight coefficient W_{ƒ1}(n-1) of the previous frame is directly used as the secondary filtering weight to perform the echo secondary filtering processing in the single-talk state. The calculation of the secondary filtering weight coefficient may be represented by Equation 14 as follow:

$${W}_{f 2}^{L} \left(n\right) = \left\{\begin{matrix}{W}_{f 1} \left(n\right) , {ξ}^{L} \left(N\right) > T 1 \\ {W}_{f 1} \left(n - 1\right) , {ξ}^{L} \left(N\right) \leq T 1\end{matrix}\right) \qquad \text{Equation 14;}$$

Wherein

$${W}_{f 2}^{L} \left(n\right)$$

represents the secondary filtering weight coefficient of the L^{th} sub-band. When the filtering weight coefficients of P sub-bands have been calculated, the secondary filtering weight coefficient value W_{ƒ2}(n) of the n^{th} frame may be obtained. Specifically, when the normalized cross-correlation coefficient ζ^{L}(n) is greater than the talkback detection threshold T1, it is determined that the current state of the electronic equipment is the dual-talk state, and the filter weight coefficient W_{ƒ1}(n) of the current frame is taken as the secondary filtering weight coefficient

$${W}_{f 2}^{L} \left(n\right)$$

of the L^{th} sub-band (S304). When the normalized cross-correlation coefficient ζ^{L}(n) is not greater than the talkback detection threshold T1, it is determined that the current state of the electronic equipment is the single-talk state, and the filter weight coefficient W_{ƒ1}(n-1) of the previous frame is taken as the secondary filtering weight coefficient

$${W}_{f 2}^{L} \left(n\right)$$

of the L^{th} sub-band (S303).

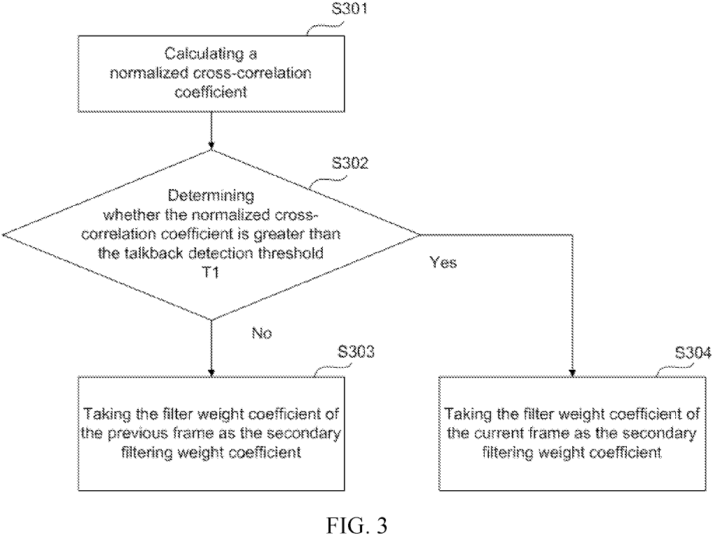

Referring to FIG. 3, FIG. 3 shows that different processing is performed on filter coefficients according to different current states.

S205: performing secondary filtering on the far-end signals and the near-end signals based on the secondary filtering weight coefficient and performing differential output to obtain a secondary differential frequency spectrum.

After the secondary filtering weight coefficient

$${W}_{f 2}^{L} \left(n\right)$$

is determined, secondary filtering processing may be performed.

In some embodiments, the step of performing secondary filtering on the far-end signals and the near-end signals based on the secondary filtering weight coefficient and performing differential output to obtain a secondary differential frequency spectrum may include:
performing secondary filtering processing on the far-end frequency domain information by using the secondary filtering weight coefficient to obtain a secondary filtering result;
subtracting the secondary filtering result from the near-end frequency domain information to obtain the secondary differential frequency spectrum.

Specifically, secondary filtering processing is performed on the far-end frequency domain information X(n) by using the secondary filtering weight coefficient W_{ƒ2}(n) to obtain the secondary filtering result; and the secondary filtering result is subtracted from the near-end frequency domain information to obtain the secondary differential frequency spectrum, which is represented by Equation 15:

$${E}_{2} \left(n\right) = D \left(n\right) - {W}_{f 2} \left(n\right) \cdot X \left(n\right) \qquad \text{Equation 15.}$$

Wherein E₂(n) represents the secondary differential frequency spectrum; W_{ƒ2}(n)•X(n) represents the result of secondary filtering.

S206: comparing the initial error frequency spectrum with the secondary differential frequency spectrum to obtain a target output frequency spectrum.

In order to eliminate the residual echo as much as possible, and at the same time, to prevent the secondary filtering from damaging the near-end signal to obtain the optimal output, the initial error frequency spectrum is compared with the secondary differential frequency spectrum to obtain the optimal output. The step of comparing the initial error frequency spectrum E₁(n) with the secondary differential frequency spectrum^{E2(n)} to obtain a target output frequency spectrum may include:
taking the initial error frequency spectrum as the target output frequency spectrum when the initial error frequency spectrum is smaller than the secondary differential frequency spectrum;
taking the secondary differential frequency spectrum as the target output frequency spectrum when the initial error frequency spectrum is larger than the secondary differential frequency spectrum.

Specifically, when the initial error frequency spectrum E₁(n) is smaller than the secondary differential frequency spectrum E₂(n), then the initial error frequency spectrum E₁(n) is taken as the target output frequency spectrum. When the initial error frequency spectrum E₁(n) is larger than the secondary differential frequency spectrum E₂(n), then the secondary differential frequency spectrum E₂(n) is taken as the target output frequency spectrum. This is represented by Equation 16 as follow:

$$E \left(n\right) = min \left({E}_{1} \left(n\right) , {E}_{2} \left(n\right)\right) \qquad \text{Equation 16;}$$

Wherein E(n) represents the target output frequency spectrum, and min represents taking the smaller one of two values.

In some embodiments, after the step S206, the method further includes:

performing inverse Fourier transform on the target output frequency spectrum followed by overlap-adding to obtain a target output signal.

Specifically, the inverse Fourier transform performed on the target output frequency spectrum E(n) may be represented by Equation 17:

$$e \left(n\right) = i f f t \left(E \left(n\right)\right) \qquad \text{Equation 17;}$$

Wherein iƒƒt represents inverse Fourier transform.

Then, a final output result of the n^{th} frame is obtained by overlap-adding, which is represented by Equation 18 and Equation 19:

$$o u t \left(n\right) = e \left(1 : M\right) + o l a \_ b u f \qquad \text{Equation 18;}$$

$$o l a \_ b u f = e \left(M + 1 : 2 \text{*} M\right) \qquad \text{Equation 19.}$$

Wherein ^{ola_buƒ} represents the overlap-adding reserved block.

In summary, as can be known from steps S204 to S206, when the secondary filtering weight coefficient converges to the optimal coefficient value, the secondary filtering weight coefficient W_{ƒ2}(n) is equal to the filter weight coefficient W_{ƒ1}(n) of the current frame. At this time, it means that the echo path estimated by the linear filter approaches the real echo path infinitely, and the residual linear echo is basically eliminated, thereby solving the problems of poor echo cancellation effect and excessive residual echo under the dual-talk state and the condition with near-end noise, effectively improving the echo cancellation effect and improving the quality of voice call.

According to the embodiments of the present application, far-end signals and near-end signals generated by an electronic equipment during a phone conversation are acquired, then preliminary filtering processing is performed on the far-end signals and the near-end signals, e.g., linear filtering processing may be performed on the far-end signals and the near-end signals to obtain an initial error frequency spectrum so as to preliminarily cancel the echo; next, a current state of the electronic equipment is determined based on the far-end signals and the near-end signals, wherein the current state includes a dual-talk state. When the current state is the dual-talk state, then a secondary filtering weight coefficient is determined to perform secondary filtering on the far-end signals and the near-end signals and perform differential output to obtain a secondary differential frequency spectrum, thereby achieving secondary filtering to cancel the echo under the dual-talk state; and the initial error frequency spectrum is compared with the secondary differential frequency spectrum to obtain a target output frequency spectrum so that the final output can cancel the residual echo as much as possible to effectively improve the quality of voice call.

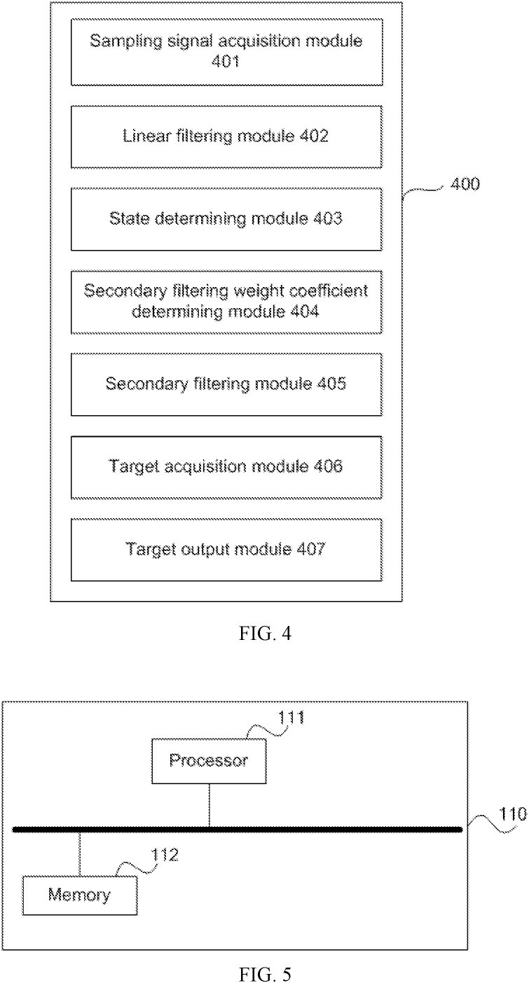

Correspondingly, as shown in FIG. 4, an embodiment of the present application further provides an echo cancellation device, which may be used for an electronic equipment. The echo cancellation device 400 includes: a sampling signal acquisition module 401, being configured to acquire far-end signals and near-end signals generated by an electronic equipment during a phone conversation; a linear filtering module 402, being configured to perform linear filtering processing on the far-end signals and the near-end signals to obtain an initial error frequency spectrum; a state determining module 403, being configured to determine a current state of the electronic equipment based on the far-end signals and the near-end signals, wherein the current state includes a dual-talk state; a secondary filtering weight coefficient determining module 404, being configured to determine a secondary filtering weight coefficient according to the current state; a secondary filtering module 405, being configured to perform secondary filtering on the far-end signals and the near-end signals based on the secondary filtering weight coefficient and performing differential output to obtain a secondary differential frequency spectrum; a target acquisition module 406, being configured to compare the initial error frequency spectrum with the secondary differential frequency spectrum to obtain a target output frequency spectrum.

According to the embodiments of the present application, far-end signals and near-end signals generated by an electronic equipment during a phone conversation are acquired, then preliminary filtering processing is performed on the far-end signals and the near-end signals, e.g, linear filtering processing may be performed on the far-end signals and the near-end signals to obtain an initial error frequency spectrum so as to preliminarily cancel the echo; next, a current state of the electronic equipment is determined based on the far-end signals and the near-end signals, wherein the current state includes a dual-talk state. When the current state is the dual-talk state, then a secondary filtering weight coefficient is determined to perform secondary filtering on the far-end signals and the near-end signals and perform differential output to obtain a secondary differential frequency spectrum, thereby achieving secondary filtering to cancel the echo under the dual-talk state; and the initial error frequency spectrum is compared with the secondary differential frequency spectrum to obtain a target output frequency spectrum so that the final output can cancel the residual echo as much as possible to effectively improve the quality of voice call.

In other embodiments, the linear filtering module 402 is further configured to: perform Fourier transform on the far-end signals to obtain far-end frequency domain information, and performing Fourier transform on the near-end signals to obtain near-end frequency domain information; perform filtering processing on the far-end frequency domain information by using the filter weight coefficient of the previous frame to obtain an echo frequency spectrum; subtract the echo frequency spectrum from the near-end frequency domain information to obtain an initial error frequency spectrum.

In other embodiments, the state determining module 403 is further configured to: divide the far-end frequency domain information and the near-end frequency domain information into a plurality of sub-bands respectively; calculate a normalized cross-correlation coefficient of the far-end frequency domain information and the near-end frequency domain information in the same sub-band; determine that the current state of the electronic equipment is a dual-talk state when the normalized cross-correlation coefficient is greater than a dual-talk detection threshold.

In other embodiments, the state determining module 403 is further configured to: calculate the cross-correlation coefficient of the far-end frequency domain information and the near-end frequency domain information in the same sub-band under the same frame; calculate the normalized cross-correlation coefficient of the far-end frequency domain information and the near-end frequency domain information in the same sub-band based on the cross-correlation coefficient.

In other embodiments, when the current state is the single-talk state, then the secondary filtering weight coefficient determining module 404 is further configured to: use the filter weight coefficient of the previous frame as the secondary filtering weight.

In other embodiments, when the current state is the dual-talk state, then the secondary filtering weight coefficient determining module 404 is further configured to: update the filter weight coefficient of the previous frame to obtain a filter weight coefficient of the current frame; use the filter weight coefficient of the current frame as the secondary filtering weight.

In other embodiments, the secondary filtering module 405 is further configured to: perform secondary filtering processing on the far-end frequency domain information by using the secondary filtering weight coefficient to obtain a secondary filtering result; subtract the secondary filtering result from the near-end frequency domain information to obtain the secondary differential frequency spectrum.

In other embodiments, the target acquisition module 406 is further configured to: take the initial error frequency spectrum as the target output frequency spectrum, when the initial error frequency spectrum is smaller than the secondary differential frequency spectrum; take the secondary differential frequency spectrum as the target output frequency spectrum when the initial error frequency spectrum is larger than the secondary differential frequency spectrum.

In other embodiments, the device 400 further includes a target output module 407, which is configured to: perform inverse Fourier transform on the target output frequency spectrum followed by overlap-adding to obtain a target output signal.

It shall be noted that, the above device may execute the method provided according to the embodiment of the present application, and has corresponding functional modules and beneficial effects for executing the method. Reference may be made to the method provided according to the embodiment of the present application for technical details not described in detail in the embodiment of the device.

FIG. 5 is a schematic view of the hardware structure of a controller of the electronic equipment 100 in one embodiment of the electronic equipment 100. As shown in FIG. 5, the controller 110 includes: one or more processors 111 and a memory 112; and in FIG. 5, one processor 111 and one memory 112 are taken as examples.

The processor 111 and the memory 112 may be connected by a bus or other means, and the bus connection is taken as an example in FIG. 5

As a nonvolatile computer readable storage medium, the memory 112 may be used to store nonvolatile software programs, nonvolatile computer executable programs and modules, such as program instructions/modules (e.g., the sampling signal acquisition module 401, the linear filtering module 402, the state determining module 403, the secondary filtering weight coefficient determining module 404, the secondary filtering module 405, the target acquisition module 406 and the target output module 407 shown in FIG. 4) corresponding to the echo cancellation method in the embodiments of the present application. The processor 111 executes various functional applications and data processing of the controller, i.e., implements the echo cancellation method provided by the above embodiments of the method, by running the nonvolatile software programs, instructions and modules stored in the memory 112.

The memory 112 may include a program storage area and a data storage area, wherein the program storage area may store operating systems and application programs required by at least one function; and the data storage area may store data created according to the use of the electronic equipment 100 or the like. In addition, the memory 112 may include a high-speed random-access memory, and may also include a nonvolatile memory, such as at least one magnetic disk memory device, flash memory device, or other nonvolatile solid-state memory devices. In some embodiments, the memory 112 optionally includes memories remotely provided relative to the processor 111, and these remote memories may be connected to a signal long-time recording device through a network. Examples of the above network include, but not limited to, the Internet, Intranet, local area networks, mobile communication networks and combinations thereof.

The one or more modules are stored in the memory 112, and when executed by the one or more processors 111, the one or more modules execute the echo cancellation method in any of the embodiments of the method described above, e.g., execute the above-described method steps of S201 to S206 of the steps of the method in FIG. 2; and implement the functions of the modules 401 to 407 in FIG. 4.

The products described above may execute the methods provided according to the embodiments of the present application, and have corresponding functional modules and beneficial effects for executing the methods. For technical details not described in detail in this embodiment, reference may be made to the method provided according to the embodiments of the present application.

An embodiment of the present application provides a nonvolatile computer readable storage medium, in which computer executable instructions are stored. The computer executable instructions, when executed by one or more processors, e.g., one processor 111 in FIG. 5, may cause the one or more processors described above to execute the echo cancellation method in any of the embodiments of the method described above, e.g., execute the above-described method steps of S201 to S206 of the steps of the method in FIG. 2; and implement the functions of the modules 401 to 407 in FIG. 4.

The embodiments of the devices described above are only for illustrative purpose. The units illustrated as separate components may be or may not be physically separated, and components displayed as units may be or may not be physical units. That is, these units and components may locate in one place or distributed over multiple network units. Some of the modules may be selected according to actual needs to achieve the purpose of the solution of the embodiment.

From the description of the above embodiments, those of ordinary skill in the art may clearly appreciate that each embodiment may be realized by means of software plus a general hardware platform, and of course, it may also be realized by hardware. As shall be appreciated by those of ordinary skill in the art, the implementation of all or part of the processes in the embodiments of the methods described above may be completed by instructing related hardware through a computer program, and the program may be stored in a computer readable storage medium. When it is executed, the program may include the processes of the embodiments of the methods described above. The storage medium may be a magnetic disk, an optical disk, a Read-Only Memory (ROM) or a Random Access Memory (RAM) or the like.

Finally, it shall be noted that, the above embodiments are only used to illustrate the technical solutions of the present application, and are not intended to limit the present application. Under the idea of the present application, technical features in the above embodiments or different embodiments may also be combined, the steps may be implemented in any order, and many other variations in different aspects of the present application as described above are possible, and these variations are not provided in details for conciseness. Although the present application has been described in detail with reference to the foregoing embodiments, those of ordinary skill in the art shall appreciate that, the technical solutions described in the foregoing embodiments may still be modified or some of the technical features may be equivalently replaced. These modifications or replacements do not make the essence of the corresponding technical solutions deviate from the scope of the technical solutions of various embodiments of the present application.

What is claimed is:

1. A method for echo cancellation comprising:
acquiring far-end signals and near-end signals generated by an electronic equipment during a phone conversation;
performing linear filtering processing on the far-end signals and the near-end signals to obtain an initial error frequency spectrum;
determining a current state of the electronic equipment based on the far-end signals and the near-end signals, wherein the current state comprises a dual-talk state;
determining a secondary filtering weight coefficient according to the current state;
performing secondary filtering on the far-end signals and the near-end signals based on the secondary filtering weight coefficient and performing differential output to obtain a secondary differential frequency spectrum;
comparing the initial error frequency spectrum with the secondary differential frequency spectrum to obtain a target output frequency spectrum.

2. The method according to claim 1, wherein the step of performing linear filtering processing on the far-end signals and the near-end signals to obtain an initial error frequency spectrum comprises:
performing Fourier transform on the far-end signals to obtain far-end frequency domain information, and performing Fourier transform on the near-end signals to obtain near-end frequency domain information;
performing filtering processing on the far-end frequency domain information by using a filter weight coefficient of previous frame to obtain an echo frequency spectrum;
subtracting the echo frequency spectrum from the near-end frequency domain information to obtain an initial error frequency spectrum.

3. The method according to claim 2, wherein the step of determining a current state of the electronic equipment based on the far-end signals and the near-end signals comprises:
dividing the far-end frequency domain information and the near-end frequency domain information into a plurality of sub-bands respectively;
calculating a normalized cross-correlation coefficient of the far-end frequency domain information and the near-end frequency domain information in the same sub-band;
determining that the current state of the electronic equipment is the dual-talk state, when the normalized cross-correlation coefficient is greater than a dual-talk detection threshold;
determining that the current state of the electronic equipment is a single-talk state, when the normalized cross-correlation coefficient is not greater than the dual-talk detection threshold.

4. The method according to claim 3, wherein the step of calculating a normalized cross-correlation coefficient of the far-end frequency domain information and the near-end frequency domain information in the same sub-band comprises:
calculating a cross-correlation coefficient of the far-end frequency domain information and the near-end frequency domain information in the same sub-band, under the same frame;
calculating the normalized cross-correlation coefficient of the far-end frequency domain information and the near-end frequency domain information in the same sub-band based on the cross-correlation coefficient.

5. The method according to claim 3, wherein the step of determining the secondary filtering weight according to the current state comprises:
using the filter weight coefficient of previous frame as the secondary filtering weight, when the current state of the electronic equipment is a single-talk state.

6. The method according to claim 3, wherein the step of determining the secondary filtering weight according to the current state comprises:
updating the filter weight coefficient of the previous frame to obtain a filter weight coefficient of the current frame; and
using the filter weight coefficient of the current frame as the secondary filtering weight, when the current state of the electronic equipment is the dual-talk state.

7. The method according to claim 2, wherein the step of performing secondary filtering on the far-end signals and the near-end signals based on the secondary filtering weight coefficient and performing differential output to obtain a secondary differential frequency spectrum comprises:
performing secondary filtering processing on the far-end frequency domain information by using the secondary filtering weight coefficient to obtain a secondary filtering result;
subtracting the secondary filtering result from the near-end frequency domain information to obtain the secondary differential frequency spectrum.

8. The method according to claim 1, wherein the step of comparing the initial error frequency spectrum with the secondary differential frequency spectrum to obtain a target output frequency spectrum comprises:
taking the initial error frequency spectrum as the target output frequency spectrum, when the initial error frequency spectrum is smaller than the secondary differential frequency spectrum;
taking the secondary differential frequency spectrum as the target output frequency spectrum, when the initial error frequency spectrum is larger than the secondary differential frequency spectrum.

9. The method according to claim 1, wherein after the step of comparing the initial error frequency spectrum with the secondary differential frequency spectrum to obtain a target output frequency spectrum, the method further comprises:
performing inverse Fourier transform on the target output frequency spectrum followed by overlap-adding to obtain a target output signal.

10. An electronic equipment, comprising:
at least one processor and a memory, the memory being communicatively connected with the processor, the memory storing instructions executable by the at least one processor, the instructions being executed by the at least one processor to enable the at least one processor to execute a method for echo cancellation, wherein the method for echo cancellation comprises:
acquiring far-end signals and near-end signals generated by an electronic equipment during a phone conversation;
performing linear filtering processing on the far-end signals and the near-end signals to obtain an initial error frequency spectrum;
determining a current state of the electronic equipment based on the far-end signals and the near-end signals, wherein the current state comprises a dual-talk state;
determining a secondary filtering weight coefficient according to the current state;
performing secondary filtering on the far-end signals and the near-end signals based on the secondary filtering weight coefficient and performing differential output to obtain a secondary differential frequency spectrum;
comparing the initial error frequency spectrum with the secondary differential frequency spectrum to obtain a target output frequency spectrum.

11. The electronic equipment according to claim 10, wherein the step of performing linear filtering processing on the far-end signals and the near-end signals to obtain an initial error frequency spectrum comprises:
performing Fourier transform on the far-end signals to obtain far-end frequency domain information, and performing Fourier transform on the near-end signals to obtain near-end frequency domain information;
performing filtering processing on the far-end frequency domain information by using a filter weight coefficient of previous frame to obtain an echo frequency spectrum;
subtracting the echo frequency spectrum from the near-end frequency domain information to obtain an initial error frequency spectrum.

12. The electronic equipment according to claim 11, wherein the step of determining a current state of the electronic equipment based on the far-end signals and the near-end signals comprises:
dividing the far-end frequency domain information and the near-end frequency domain information into a plurality of sub-bands respectively;
calculating a normalized cross-correlation coefficient of the far-end frequency domain information and the near-end frequency domain information in the same sub-band;
determining that the current state of the electronic equipment is the dual-talk state, when the normalized cross-correlation coefficient is greater than a dual-talk detection threshold;
determining that the current state of the electronic equipment is a single-talk state, when the normalized cross-correlation coefficient is not greater than the dual-talk detection threshold.

13. The electronic equipment according to claim 12, wherein the step of calculating a normalized cross-correlation coefficient of the far-end frequency domain information and the near-end frequency domain information in the same sub-band comprises:
calculating a cross-correlation coefficient of the far-end frequency domain information and the near-end frequency domain information in the same sub-band, under the same frame;
calculating the normalized cross-correlation coefficient of the far-end frequency domain information and the near-end frequency domain information in the same sub-band based on the cross-correlation coefficient.

14. The electronic equipment according to claim 12, wherein the step of determining the secondary filtering weight according to the current state comprises:
using the filter weight coefficient of previous frame as the secondary filtering weight, when the current state of the electronic equipment is a single-talk state.

15. The electronic equipment according to claim 12, wherein the step of determining the secondary filtering weight according to the current state comprises:
updating the filter weight coefficient of the previous frame to obtain a filter weight coefficient of the current frame; and
using the filter weight coefficient of the current frame as the secondary filtering weight, when the current state of the electronic equipment is the dual-talk state.

16. The electronic equipment according to claim 11, wherein the step of performing secondary filtering on the far-end signals and the near-end signals based on the secondary filtering weight coefficient and performing differential output to obtain a secondary differential frequency spectrum comprises:
performing secondary filtering processing on the far-end frequency domain information by using the secondary filtering weight coefficient to obtain a secondary filtering result;
subtracting the secondary filtering result from the near-end frequency domain information to obtain the secondary differential frequency spectrum.

17. The electronic equipment according to claim 10, wherein the step of comparing the initial error frequency spectrum with the secondary differential frequency spectrum to obtain a target output frequency spectrum comprises:
taking the initial error frequency spectrum as the target output frequency spectrum, when the initial error frequency spectrum is smaller than the secondary differential frequency spectrum;
taking the secondary differential frequency spectrum as the target output frequency spectrum, when the initial error frequency spectrum is larger than the secondary differential frequency spectrum.

18. The electronic equipment according to claim 10, wherein after the step of comparing the initial error frequency spectrum with the secondary differential frequency spectrum to obtain a target output frequency spectrum, the method further comprises:
performing inverse Fourier transform on the target output frequency spectrum followed by overlap-adding to obtain a target output signal.
